(19) United States
(12) Patent Application Publication
(10) Pub. No.: US 2005/0119390 A1
(43) Pub. Date: Jun. 2, 2005

(54) Process for the simultaneous formation of surface and sub-surface metallic layers in polymer films

(75) Inventors: Gregory A. Gaddy, Odenton, MD (US); Diane M. Stoakley, Yorktown, VA (US); Gilda A. Miner, Newport News, VA (US); Edward P. Locke, Norfolk, VA (US); Catharine C. Fay, Yorktown, VA (US); German C. Mills, Auburn, AL (US)

Correspondence Address: NATIONAL AERONAUTICS AND SPACE ADMINISTR;ATION LANGLEY RESEARCH CENTER, 3 LANGLEY BOULEVARD, MAIL STOP 212, HAMPTON, VA, 236812199, US

(73) Assignee: USA as represented by the Administrator of the National Aeronautics and Space Administration, Washington, DC (US)

(21) Appl. No.: 10/956,528

(22) Filed: Sep. 23, 2004

Related U.S. Application Data
(60) Provisional application No. 60/527,881, filed on Dec. 2, 2003.

(51) Int. Cl. C08K 3/08; C08K 3/10

(52) U.S. Cl. 524/440; 524/434

(57) ABSTRACT

Self-metallizing polyimide films are created by doping polyamic acid solutions with metallic ions and solubilizing agents. Upon creating a film, the film is exposed to ultraviolet light for a specific time and then cured. The resulting film has been found to have a metallic surface layer and a metallic subsurface layer (interlayer). The layer separating the metallic layer has a uniform dispersion of small metal particulates within the polymer. The layer below the interlayer has larger metal particulates uniformly distributed within the polymer.

### CLAIM OF BENEFIT OF PROVISIONAL APPLICATION

Pursuant to 35 U.S.C. § 119, the benefit of priority of provisional application 60/527,881, the filing date of Dec. 2, 2003, is claimed for this non-provisional application.

### ORIGIN OF THE INVENTION

The invention described herein was made in part by employees of the United States Government and may be manufactured and used by and for the Government of the United States for government purposes without the payment of any royalties thereon or therefore.

### BACKGROUND OF THE INVENTION

1. Field of the Invention

This invention relates generally to polymeric films and coatings. It relates particularly to irradiated, thermally cured polyimide films.

2. Description of Related Art

It has been known for a relatively long time that bulk properties of materials are not necessarily exhibited when reduced in size to the nano size regime. At least one group of scientists has been researching the metallization of high-performance polymer films containing metallic nanoparticulates in the bulk of the film.

Providing reflective surfaces on exterior surfaces of polyimide films has been done. U.S. Pat. No. 6,019,926 discusses a method of providing reflective silvered polyimide films via in situ thermal reduction silver (I) complexes. Additionally, technology such as U.S. Pat. No. 5,520,960 relates to electrically conductive polyimides containing silver trifluoroacetylacetonate. U.S. Pat. No. 5,575,955 discusses the composition and process of making an electrically conductive polyimide film containing gold (III) ions. Additionally, U.S. Pat. No. 5,677,418 shows a method of producing reflective self-metallizing polyimide films.

It should be noted that all these disclosures relate to providing a reflective top surface on a polyimide film. This general technology is referred to as Self-Metallized Film Technology and typically produces a surface metallized flexible polymer film having tunable specular reflectivity and surface electrical conductivity. In fact, it is known that polymers can inhibit the aggregation of metal particles by surface modifications that alter the specific surface energy of the metallic particles, and thus their attraction to each other. W. Caseri, “Nanocomposites of polymers and metals or semiconductors: Historical background and optical properties,” Macromol. Rapid Commun 21, 705-722 (2000).

Self-Metallized Film Technology, a homogeneous solution containing a soluble metal complex in a polymer resin is typically cast as a thin film and then subjected to thermal curing. The cure process induces in situ metal ion reduction in the formation of reduced metal clusters that produce a conductive reflective metallic surface layer with additional nanometer-sized metal particulates imbedded in the bulk of the film. As long as only a reflective/conductive metallic surface layer is desired, this is believed to provide a satisfactory method of providing a reflective/conductive metallic surface layer on the polyimide film. Unfortunately, during this process, the metal particulates imbedded within the bulk of the film are dispersed in density gradients characterized by non-uniformity in the size of these nanometer-size particles.

Apparently some work has focused on electroless deposition of silvery interlayers within polymer films. Specifically, L. E. Manring prepared an article entitled “Electroless Deposition of Silver as an Interlayer Within Polymer Films,” Polymer Communications, March 1987, Volume 28, pp. 68-71. This document discusses forming a metal layer as an interlayer within polymeric films using counter-current diffusion as opposed to the old method of electroless-deposition. The Journal of Physics and Chemistry provided an article in 1987, entitled “The Kinetics of Metal Interlayer Growth in Polyimide Films: Metal Distributions in the Non-Shady-state Regime and with Constraints of Patterned Boundaries.” J. Phys. Chem., 1987, pps. 6699-6705. This article defined “interlayer” as being known in the art to distinguish the structure from conventional surface-metallized films. The metal in the interlayer in this reference is precipitated from the reaction of dissolved metal ions either with a reducing agent or with mobile electrons. These two components (reducing agent or mobile electrons) are introduced into the film from opposite surfaces. It is believed that the transport of reagents governs the location of the inner layer. This article discusses how one might control the reaction/precipitation process to predict and control electrical and optical properties of the final film product.

Earlier methods of achieving an embedded metallic layer involve counter-current diffusion in free standing films. These processes do not typically result in an additional well-adhered surface metallic layer. Furthermore, these processes typically do not provide uniform size and distribution of metallic nanoparticulates in the bulk of the film above and below the interlayer. Finally, the films of the previous work were not reported to exhibit dimensional changes upon exposure to white light, and the optical properties of these films were not reported in the known references.

While the use of electrical and chemical processes, including the use of a reducing agent with mobile electrons, is known to produce an interlayer, there is believed to be a need for an improved method of providing an interlayer within polymeric films.

### SUMMARY OF THE INVENTION

It is therefore an object of the invention to provide a new method of producing interlayers in polymeric films.

It is another object of the present invention to provide a method of producing a conductive surface layer in addition to an interlayer in a polymeric film.

It is another object of the present invention to provide an improved method for advantageously positioning an interlayer within a film of a polymeric material such as polyimide.

Accordingly, a polyimide film is produced to provide a metallic upper surface of the film and at least one metallic interlayer below and spaced from the metallic upper surface of the film. The process for producing the film including the metallic upper surface as well as the metallic interlayer includes providing a polyamic acid resin doped with a metallic salt. The doped resin is shaken or stirred for four hours and stored prior to casting on a glass substrate. A film is formed on a glass substrate, then placed directly into a horizontally positioned photochemical reactor, exposing the film to ultraviolet light having 350 nanometer photons with a light intensity ranging from about 4-18 mW/cm² for varying amounts of time between 4 and 25 hours. Other ranges of time could be used dependent upon the intensity of the light source used for irradiation. After photolysis, the films are cured, using a programmable forced air oven to remove DMAc solvent in the polyamic acid and to induce imidization of the polyamic acid, and further reduce the palladium ions.

The resulting film includes a metallic layer on the upper surface layer and a metallic interlayer which may act as etalons or Fabry-Perot filters. This is believed to occur because the resultant Pd/PI film contains two partially transmitting parallel mirrors of similar thickness separated by a gap. Accordingly, such structure may be useful as laser cavities, or for other commercial applications such as narrow band pass filters and/or microelectromechanical (MEMS) switches.

### BRIEF DESCRIPTION OF THE DRAWINGS

The patent or application file contains at least one photograph executed in color. Copies of this patent or patent application publication with color drawing(s) will be provided by the Office upon request and payment of the necessary fee.

The particular features and advantages of the invention as well as other objects will become apparent from the following description taken in connection with the accompanying drawings in which:

FIG. 1 is a color photograph of a cross section of film taken with a Transmission Electron Micrograph (TEM), illustrating the density gradient of particulates formed in accordance with prior art manufacturing techniques when formed under nitrogen;

FIG. 2 is a color photograph of a cross section of film taken with a Transmission Electron Micrograph (TEM), illustrating the lack of uniformity of particulates formed on the surface and within the film, in accordance with prior art manufacturing techniques when formed under forced air;

FIG. 3 is a color photograph of a top surface of a film produced in accordance with the method of the presently preferred embodiment of the present invention;

FIG. 4 is a color photograph of a cross section of the film shown in FIG. 3, taken with a Transmission Electron Micrograph (TEM), illustrating the metallic upper surface layer, the metallic interlayer, and the particulate size differences between the nanometer-sized palladium particles between the metallic layers and those particulates located below the interlayer;

FIG. 5 is a color photograph taken with a Transmission Electron Micrograph (TEM) of the width of the cross section shown in detail in FIG. 4, illustrating the glass substrate below the film layer; and

FIG. 6 is graphical representation showing diffuse reflectance spectra of irradiated thermally cured Pd/PI film.

FIGS. 7a-7c are depictions in cross-section of a seven-layered film produced by the presently described process.

### DETAILED DESCRIPTION OF THE PREFERRED EMBODIMENTS OF THE INVENTION

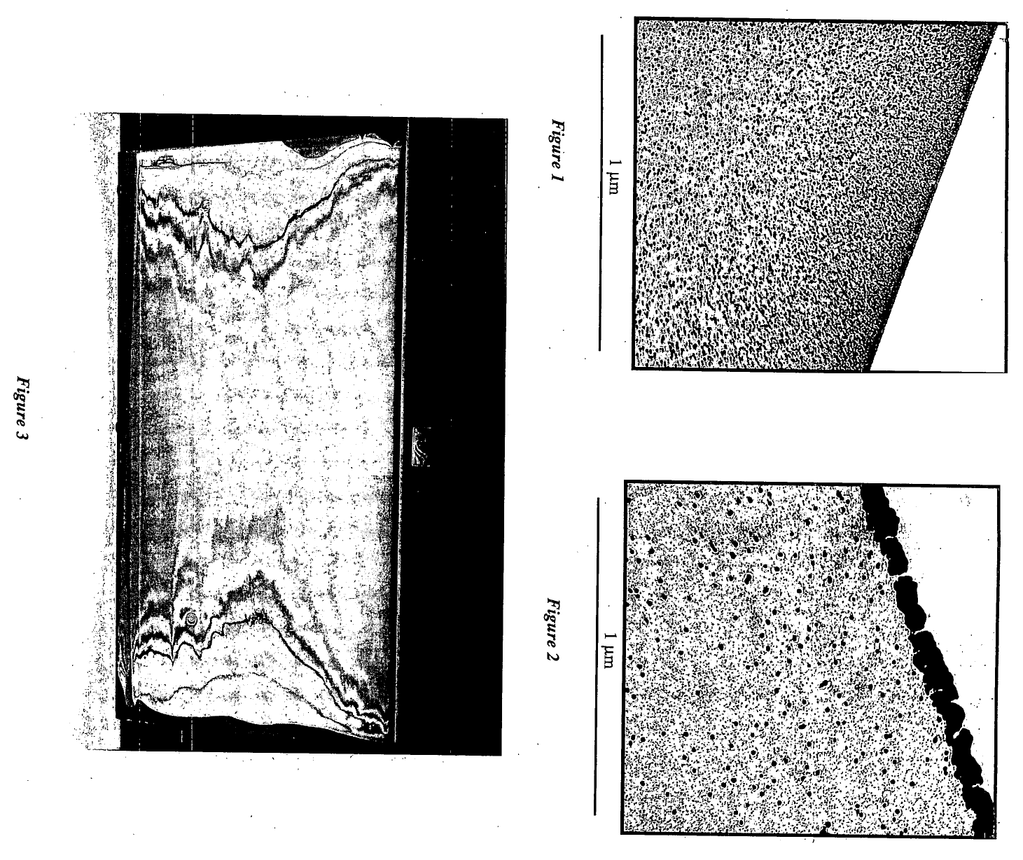

The Self-Metallizing Film Technology as described above relates to the production of surface metallized flexible polymer films having tunable specular reflectivity and surface electrical conductivity. The existing technology has been found satisfactory to provide a one-step method for achieving metallized polymer film with superior adhesion at the metal-polymer interface. However, if one were to entertain an interest in achieving monodispersed nanoparticulates in the bulk of the polymer, existing processes have been found to produce density gradients of the dispersed metallic particulates, and non-uniformity in the size of the dispersed nanometer-sized particles. FIGS. 1 and 2 are illustrative of a thermally cured palladium-containing polymide when nitrogen cured (FIG. 1) and when forced air cured (FIG. 2). Films of 3.9% Pd:BTDA/4,4′-ODA exhibit non-uniformity of nanoparticulate dispersion in FIG. 1 as well as bimodal size formation of palladium particulates in the bulk of the film in FIG. 2.

In an effort to achieve mono-dispersed metal particles in a dielectric polymeric matrix, the applicants entertained the possibility of photo-reduction of metal ions prior to thermal cure. This was initially performed in an attempt to control the resulting metallic particle size and the ultimate distribution of metallic particles in the polymeric film. However, the unexpected result of this process was the production of a metallic interlayer wherein two parallel metallic layers are produced separated by a polymeric/nanoparticulate region. In fact, in the preferred embodiment, films formed using the process exhibit movement in response to white light as well as exhibiting optical properties typical of Fabry-Perot filters (or etalons).

A wide variety of dianhydrides and diamines could be used within the practice of the present invention. Dianhydrides could include: 3,3′,4,4′-benzophenonetracarboxylic dianhydride (BTDA); 4,4′-isophthaloyldiphthalic anhydride (IDPA); 3,3′,4,4′-bipheneyltetracarboxylic dianydride (BPDA); 2,2-bis(3,4′-dicarboxyphenyl)hexafluoropropane dianhydride (6FDA); pyromellitic dianhydride (PMDA); 4,4′-oxydiphthalic dianhydride (OPDA); and 4,4′-bis(3,4-dicarboxy)diphenyl sulfide dianhydride. The dianhydrides could also be provided as equivalent tetracarboxylic acids. The diamines could include: phenylenediamine (PDA); benzidine; 4,4′oxydianiline (QDA); 1,3 or 1,4-bis(4-aminophenoxy-4′-benzoyl)benzene (1,3 or 1,4-BABB); 1,3-bis(aminophenoxy)benzene (APB); diaminophenylmethane (MDA); diaminobenzophenone (DABP); diaminophenylsulfone (DDSO₂); and 2,2-bis [4-(4-aminophenoxy)phenyl]hexafluoropropane (4-BDAF).

This list is provided for exemplary purposes only, and it should be understood that other dianhydrides and diamines can be used within the practice of this invention. The dianhydrides and diamines can be used to prepare both polyamic acid precursor solutions which contain one or more dianhydrides and one or more diamines and solvent, or solubilized polyimide solutions which contain polyimide prepared from the polyamic acid precursors with the polyimide solubilized in a solvent. It should also be understood that precursors which include both an amine and anhydride moiety can be polymerized by condensation polymerization to produce a polymide.

BTDA and 4,4′-ODA were obtained from Allco Chemical and Wakayama Seika Kogyo, respectively. PdCl₂, N,N-dimethylacetamide (DMAc) and dimethyl sulfide were obtained from Aldrich. These chemicals were utilized by the applicant as received without further purification. Polyamic acid resins (12-15% w/w) were prepared by reacting equimolar amounts of BTDA and 4,4′-ODA in anhydrous DMAc. The resin was stirred under a nitrogen (N₂) blanket for 15 to 20 hours and then stored at 10° Celsius under nitrogen. Pd[S(CH₃)₂]₂CL₂ was synthesized from PdCl₂ as described by G. Kauffman and D. Cowan in cis- AND trans-DICHLOROBIS(DIETHYL SULFIDE) PLATINUM(II), Inorganic Synthesis, 1960, pps. 211-215, which description is hereby incorporated by reference.

Resins were doped at room temperature with Pd[S(CH₃)₂]₂Cl₂ so that the polymer films contained 5 percent by weight (wt. %) palladium (Pd). The doped resins were sealed under nitrogen (N₂) and placed on an automatic shaker for four hours (4 h), and then stored at 10° Celsius. All films were cast on glass substrates at 330 microns thick using a doctor blade or a 2″ Gardco Microm Film Applicator. The films on the glass substrates were placed directly into a horizontally positioned Rayonet™ 200 photochemical reactor equipped with RPR-3500 A lamps and exposed to 350 nm photons (light) with a a light intensity ranging from 4-18 mW/cm² for varying amounts of time between four and twenty-five (25) hours. After photolysis, the films were cured using a programmable forced air oven (Blue M model DC-256 C) to remove DMAc solvent, induce imidization of the polyamic acid and further reduce the Pd²⁺ ions. The oven was programmed to heat the samples in successive steps of 100, 200 and 300° Celsius for one hour each, returning to ambient temperature over two hours. Cured films had thicknesses that ranged from approximately 15-60 micrometers as determined with a TMI 49-60 micrometer.

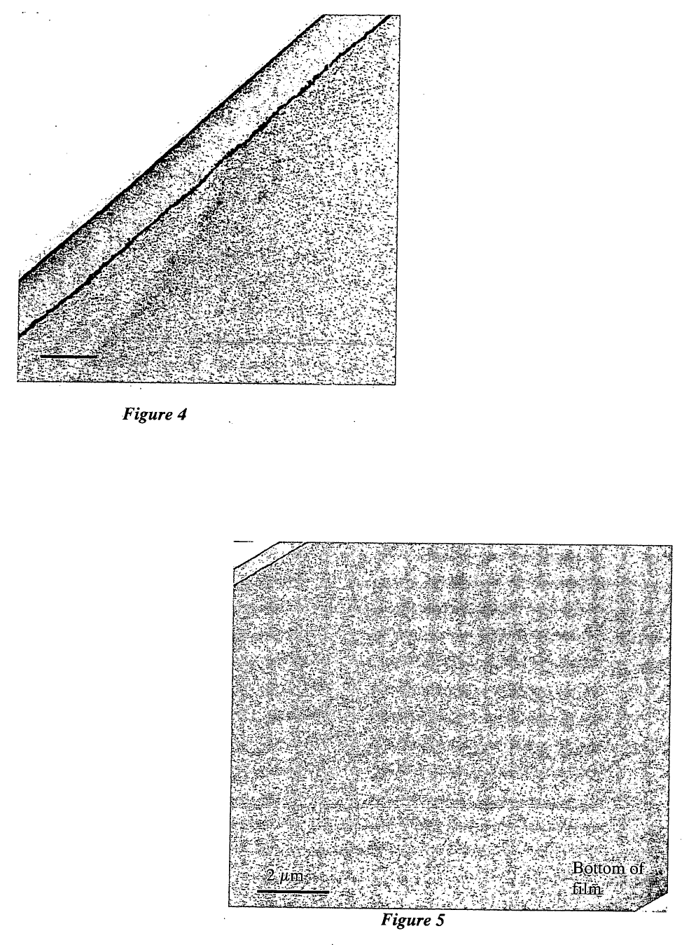

The irradiated, thermally cured polyimide films of the present embodiment of the present invention resulted in several unexpected and unique properties, including the appearance of multiple colors on the upper surface of the polymer film, as shown in FIG. 3. The areas appear to be colored as a result of the formation of an embedded metallic interlayer below the metallic upper surface of the film. Variations in the distance between the metallic interlayer and the surface metal layer produce a multi-colored appearance resulting from wavelength interference reflections off these two metallic layers. In addition to the appearance of the surface and inter-metallic layers, two distinctly different nanometer-sized palladium (Pd) particles are also produced. Palladium (Pd) particles, 2-4 nanometers (nm) in size, are found dispersed between the metallic surface and interlayer while palladium (Pd) particles, 14-16 nm in size are found below the metallic interlayer. See FIGS. 4 and 5.

The upper surface of the film shown in FIGS. 3-5 was observed to be essentially a continuous layer of palladium (Pd). A second essentially continuous layer of palladium was formed internally in the film, just below the surface. The distance between the surface and subsurface layers was about 200-400 nanometers and the gap between the layers contained a uniform dispersion of nanometer sized (2-4 nm, dia.) palladium (Pd) particles. (Non-irradiated polyamic acid films doped with palladium ions and thermally imidized only exhibited a continuous metallic surface layer as shown in FIGS. 1 and 2).

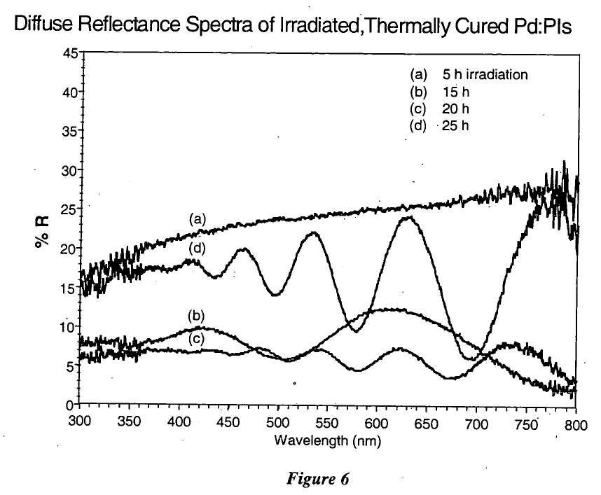

The occurrence of the metallic interlayer creates distinctly different properties than palladium/polyimide films of the prior art having non-irradiated, thermally cured Pd/PI films. The metallic interlayer and the upper surface layer created by first irradiating a polyamic acid film containing solubilized palladium metal ions followed by thermal cure has been shown to provide polyimide films that act as etalons or Fabry-Perot filters. This effect is believed to occur because the resultant Pd/PI film of the present invention provides two partially transmitting parallel mirrors of similar thickness separated by a gap. Multiple internal reflections consistent with etalon optical behavior are seen by diffuse reflectance spectra as illustrated in FIG. 6. This behavior likely provides the ability to utilize these materials in lasers and as narrow-bandpass filters.

In addition to the etalon nature of these films, the irradiated, thermally cured Pd/PIs demonstrate reversible movement when illuminated by white light. For example, short lengths (˜1 inch) of the nominal 3-5 mil thick polymer films bend almost 90 degrees in response to white light. This phenomena provides a use of products created by the process described herein for products having an application as microelectromechanical system (MEMS) switches.

In accordance with the presently preferred embodiment, undoped BTDA/ODA polyimide films have been found to exhibit a density of 1.38 grams/ml, a glass transition temperature by TMA of 280° Celsius, a dielectric constant at 10 GHz of 3.15, a R.T. tensile strength of 17,000 lbs/inch², an R.T. tensile modulus of 420,000 lbs/inch², a CTE of 39 ppm/° C., a refractive index of 2.69, and an inherent viscosity of polyamic acid at 35° C. of 1.2-1.6 dl/b. The polyimide is further believed to be insoluble in common organic solvents. Other polymer films which are utilized with the method of irradiating and then thermally curing metallic doped resins to produce films may exhibit different physical properties and characteristics.

While Pd[S(CH₃)₂]₂Cl₂ is described as the doping agent above, AgOOCCF₃ has also been successfully utilized along with CuOOCCF₃, Ni(CH₃COCHCOCH₃)₂, Ag(TfA), Au(ptm), Pt[C₂H₅)₂S]₂Cl₂, C₅H₅Co(CO)₂, Co(CF₃COCHCOCF₃)₂, Cu(CF₃COCHCOCF₃)₂, Fe(CH₃COCHCOCH₃)₂,NaAuCl₂, Na⁺AuCl₄, and (C₂H₅)₃PAuN(Phthal) in Self-Metallized Film Technology, and could be used in the irradiated, thermally cured polyimide films of the present invention. Combinations of doping agents could also be utilized. Other doping agents could also be utilized. Dopant percentages of about 5 to 20 percent have been tested. Other percentages could also be effective depending upon the desired application.

Once the films of the present invention were created, they were tested for various properties. The multi-layer film is believed to have uses as optical filters and absorbers. The nanoparticulates can be made into composites that exhibit new electromagnetic constitutive properties.

Specifically nanoparticle dispersions are made with a single-stage self-metallizing protocol. Metal nanoparticle films usually evolve from a single homogeneous resin solution containing a metal precursor (doping agent) that is exposed to UV radiation and a controlled thermal environment. The combination of thermal curing and UV exposure is believed to create a multiphase material comprised of low volume fractions of dispersed metallic clusters (10-20 nanometers (nm) in size) and high concentrations of nanoparticles which form layered embedded films. Examples of the composite have separated inner-layers of increased volume fraction of metal and layer separation is controlled by UV exposure. An example is shown in FIGS. 4 and 5. These materials exhibit significant absorption in the optical and near infrared (IR) region. Furthermore they exhibit mechanical properties similar to bi-metallic layers. They display reversible bending with exposure to light and an accompanying rapid temperature increase. In fact using an IR thermometer, the temperature increase was measured at 100° Celsius.

It should be apparent that this technology could represent a significant advance or a breakthrough in the preparation of polymer films with high performance electro-optical characteristics. While palladium (Pd) was the focus of the example, it is believed that other metallics (such as silver, gold, platinum and copper) might provide similar behavior at a lower cost than palladium.

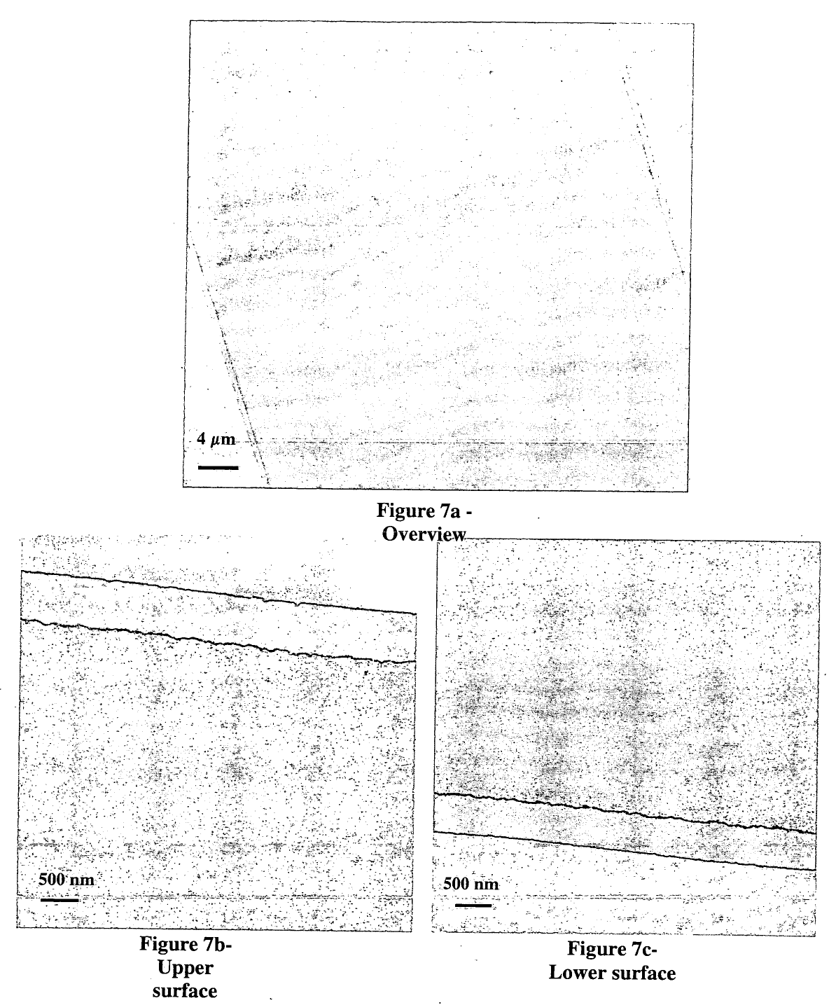

While only a single interlayer is shown in FIGS. 4 and 5, it will be understood to one of ordinary skill in the art that films that are UV irradiated, and subsequently cured in a forced air oven (or otherwise) in a free standing mode (not on a substrate as described above), will have a metallic layer on both outer surfaces and interlayers interior to both the upper and lower film surfaces as illustrated in FIGS. 7a-c. This produces a seven layer film and the lower three film layers appear similar to the upper three layers shown in FIGS. 4 and 5 (except they are at the bottom of the film). The fourth, or middle layer is located between the two interlayers.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

1. A process for the simultaneous formation of a surface and a subsurface metallic layer in polymer films comprising:
reacting an aromatic dianhydride with an aromatic diamine in a solvent to produce a polyamic acid solution;
doping the polyamic acid solution with metallic ions to provide a doped solution;
preparing a film from the doped solution;
irradiating the film with ultraviolet light; and then
curing the film to convert the doped solution to the corresponding polyimide and reduce the metallic ions to precipitate metallic particles within a cured film, wherein the cured film is characterized by a surface metallic layer, a subsurface metallic layer spaced from the surface metallic layer by a first metal particle/polymeric layer intermediate the surface and subsurface metallic layers and a second metal particle/polymeric layer, said subsurface metallic layer located intermediate the first and second metal particle/polymeric layers.

2. The process of claim 1 wherein the step of curing the film further comprises thermally curing the film to produce the cured film.

3. The process of claim 1 wherein the aromatic dianhydride is 4,4′-benzophenonetetracarboxylic dianhydride (BTDA).

4. The process of claim 1 wherein the aromatic diamine is 4,4′oxydianniline (ODA).

5. The process of claim 1 wherein the solvent is N,N-dimethylacetamide (DMAc).

6. The process of claim 1 wherein the step of preparing the film further comprises forming a film on a substrate.

7. The process of claim 1 wherein the step of irradiating the film with ultraviolet light further comprises exposing the film to about 350 nm light photons.

8. The process of claim 1 wherein the step of irradiating the film further comprises exposing to UV light for at least about 5 hours.

9. The process of claim 8 wherein the step of irradiating the film further comprises exposing to UV light for intermediate about 5 hours to about 25 hours.

10. The process of claim 1 wherein the step of irradiating the film further comprises exposing to UV light for less than about 25 hours.

11. The process of claim 1 wherein the metallic ions are provided as a metallic salt containing at least one of silver, gold, palladium, platinum, nickel, cobalt, iron, and copper.

12. A polymer film having a surface and a subsurface metallic layer formed by the process of:
reacting an aromatic dianhydride with an aromatic diamine in a solvent to produce a polyamic acid solution;
doping the polyamic acid solution with metallic ions to provide a doped solution;
preparing a film from the doped solution; and then
irradiating the film with ultraviolet light; and then
curing the film to convert the doped solution to the corresponding polyimide and reduce the metallic ions to precipitate metallic particles within a cured film, wherein the cured film is characterized by a surface metallic layer, a subsurface metallic layer spaced from the surface metallic layer by a first metal particle/polymeric layer intermediate the surface and subsurface metallic layers and a second metal particle/polymeric layer, said subsurface metallic layer located intermediate the first and second metal particle/polymeric layers.

13. The polymer film of claim 12 wherein the film exhibits reversible movement when illuminated by white light.

14. The polymer film of claim 12 wherein the surface metallic layer and subsurface metallic layer are parallel and separated by the first metal particle/polymeric layer and the film acts as an etalon.

15. The polymer film of claim 12 wherein the surface metallic layer and subsurface metallic layer are parallel and separated by the first metal particle/polymeric layer and the film acts as a narrow bandpass filter.
